(19) United States
(12) Patent Application Publication
(10) Pub. No.: US 2004/0035310 A1
(43) Pub. Date: Feb. 26, 2004

(54) Self-inking Stamp

(76) Inventor: Peter Zindl, Obertraun (AT)

Correspondence Address: Law Offices of Karl Hormann, P O Box 381516, Cambridge, MA, 02238-1516, US

(21) Appl. No.: 10/275,224

(22) PCT Filed: Apr. 12, 2001
(86) PCT No.: PCT/AT01/00109

(30) Foreign Application Priority Data
May 4, 2000 (AT) A 787/2000

(51) Int. Cl. B41K 1/38

(52) U.S. Cl. 101/327

(57) ABSTRACT

A self-inking stamp with overhead inking, with a lower component (1) for positioning on a surface to be stamped, with a swivel mechanism (W) for a print platen support arranged in the lower component for reciprocal swiveling movement between a stamp pad (4) and a support frame (A) and with an actuator upper component (2) movable against the bias of a spring relative to the lower component, the actuator upper portion being connected by its lateral parts (2″) to the lower component by a swivel axle of the print platen support extending through elongated openings (12) in narrow side walls of the lower component, whereby the actuator upper component is connected to the lower component by lateral elastic snap connections (7, 8) and is provided at its lower end with lateral snap recesses (9) which may be engaged by swivel axle stubs of the print platen support inserted into the guide slots of the lower component.

The invention relates to a self-inking stamp with overhead inking, with a lower component for positioning on a surface to be stamped, with a swivel mechanism for a print platen support arranged in the lower component for reciprocal swiveling movement between a stamp pad and a support frame and with an actuator upper component movable against the bias of a spring relative to the lower component, the actuator upper portion being connected by its lateral parts to the lower component by a swivel axle of the print platen support extending through elongated openings in narrow side walls of the lower component.

Such self-inking stamps are known for instance from EP 0,459,969 A1. In those stamps, the actuator upper component is structured substantially in the manner of a hood and is provided in front as well as in the rear with a recess which provides access to the stamp pad which is exchangeably inserted into a horizontal shaft of the lower stamp component.

It is an object of the invention by a novel construction of the stamp to simplify the assembly and transport thereof so that a final user may in a simple fashion himself mount the print platen made by himself and the stamp is immediately ready for use. In a stamp of the kind described above this is accomplished by the actuator upper component being connected to the lower component by lateral elastic snap connections and being provided at its lower end with lateral snap receptacles which are engageable with stubs of the swivel axis of the print platen support extending into the guide slots of the lower components.

Preferably, the snap connection between upper component and lower component is provided with snap lugs in the lateral parts of the upper component which protrude into an undercut in the lateral parts of the lower component.

In accordance with a further element of the invention there are formed in the lateral parts of the upper component and extending from the snap lugs, snap receptacles for the axle stubs of the print platen support.

The invention will hereinafter be described in greater detail on the basis of an embodiment.

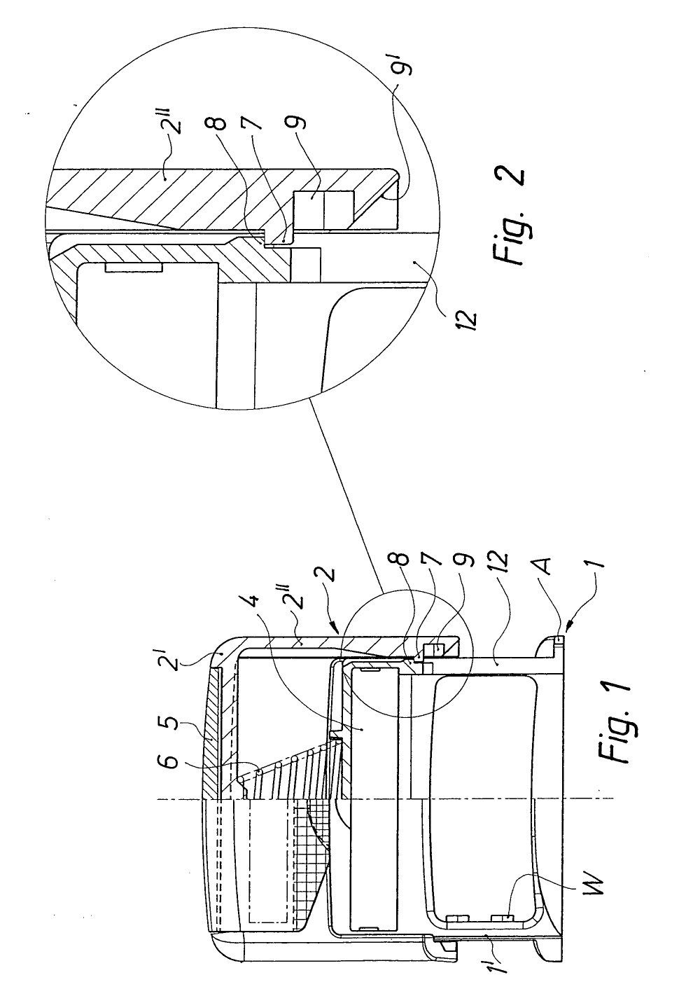

FIG. 1 depicts a stamp in accordance with the invention partly in axial section and partly completely;

FIG. 2 depicts a detail of FIG. 1; and

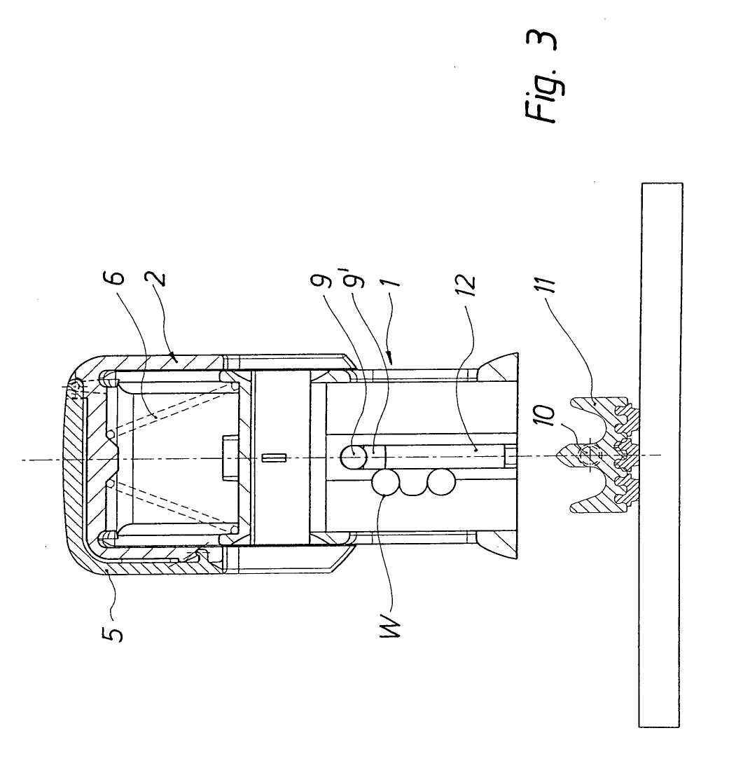

FIG. 3 is a section along line 3-3 of FIG. 1.

The self-inking stamp shown in FIG. 1 is provided with a lower stamp component 1 which contains a support frame A and a swivel mechanism W and which is connected to an actuator upper component 2 which is movable relative to the lower component 1 and connected thereto by a resilient or elastic snap connection which is shown in detail in FIG. 2.

The lower stamp component 1 receives a stamp pad 4 which is inserted in a shaft of the lower component.

In its upper hood 2′, the upper component 2 supports a pivotally openable text window 5 and, in its interior, a conical pressure spring 6 for actuating the stamp.

In the elastically deformable lateral parts 2″ of the upper component 2 there are formed, near the ends thereof, snap lugs 7 which may engage cutouts 8 of the lower component 1 when the upper component 2 is pressed onto the lower component 1 against the bias of the spring 6 over an incline 8′. Adjacent to the snap lugs 7, the upper component 2 in its lateral parts 2″ is provided with snap recesses 9 for the snap engagement of axle stubs 10 of a print platen support 11 which is inserted in guide slots 12 of the lower component. The snap connection is formed by pressing the upper component 2 onto the stamp platen support 11 across the incline 9′ as shown in FIG. 3.

1. A self-inking stamp with overhead inking, with a lower component for positioning on a surface to be stamped, with a swivel mechanism for a print platen support arranged in the lower component for reciprocal swiveling movement between a stamp pad and a support frame and with an actuator upper component movable against the bias of a spring relative to the lower component, the actuator upper portion being connected by its lateral parts to the lower component by a swivel axle of the print platen support extending through elongates openings in the narrow side walls of the lower component, characterized by the fact that the actuator upper component (2) is connected to the lower component (1) by lateral elastic snap connections (7, 8) and is provided at its lower end with lateral snap receptacles (9) which may engage stubs of the swivel axle (10) of the print platen support (11) inserted in guide slots (12) of the lower component.

2. The self-inking stamp of claim 1, characterized by the fact that the snap connection between upper component (2) and lower component (1) is provided with snap lugs (7) in the lateral parts (2″) of the upper component (2) which protrude into cutouts (8) in the side parts (1′) of the lower component (1).

3. The self-inking stamp of claim 2, characterized by the fact that adjacent the snap lugs (7) there are arranged in the lateral parts (2′) of the upper component (2) snap recesses (9) for the axle stubs (10) of the print platen support (11).
